(19) United States
(12) Patent Application Publication
(10) Pub. No.: US 2023/0239429 A1
(43) Pub. Date: Jul. 27, 2023

(54) COMMUNICATION SYSTEM AND METHOD

(71) Applicant: MEDIATEK INC., Hsinchu City (TW)

(72) Inventors: Shih-Rong KAO, Hsinchu City (TW); Cheng-Tai YEH, Hsinchu City (TW)

(21) Appl. No.: 17/825,223

(22) Filed: May 26, 2022

Related U.S. Application Data
(60) Provisional application No. 63/302,586, filed on Jan. 25, 2022.

(51) Int. Cl. H04N 7/01; H04N 7/10; G06F 13/40

(52) U.S. Cl. CPC H04N 7/01; H04N 7/10; G06F 13/4027; G06F 2213/0024; G06F 2213/0042

(57) ABSTRACT

A communication system includes a camera module and a backend module. The camera module includes an image sensor, a data converter, and a first interface. The image sensor generates a digital signal according to an optical signal. The data converter converts the digital signal into a conversion signal. The first interface transmits the conversion signal. The backend module includes a second interface and a processor. The second interface receives the conversion signal. The processor processes the received conversion signal.

### CROSS REFERENCE TO RELATED APPLICATIONS

This application claims the benefit of U.S. Provisional Application No. 63/302,586, filed on Jan. 25, 2022, the entirety of which is incorporated by reference herein.

### BACKGROUND OF THE INVENTION

### Field of the Invention

The disclosure generally relates to a communication system, and more specifically, to a communication system with high transmission efficiency.

### Description of the Related Art

Conventional designs for communication systems used in mobile devices usually have certain disadvantages, including short transmission distances, high cabling costs, and cable physical size/shape/routing constraints. These factors may negatively affect overall transmission efficiency. Accordingly, there is a need to propose a novel solution for solving the problems of the prior art.

### BRIEF SUMMARY OF THE INVENTION

In an exemplary embodiment, the disclosure is directed to a communication system that includes a camera module and a backend module. The camera module includes an image sensor, a data converter, and a first interface. The image sensor generates a digital signal according to an optical signal. The data converter converts the digital signal into a conversion signal. The first interface transmits the conversion signal. The backend module includes a second interface and a processor. The second interface receives the conversion signal. The processor processes the received conversion signal.

In some embodiments, the first interface and the second interface are two USB (Universal Serial Bus) interfaces coupled to each other through a wired cable.

In some embodiments, the first interface and the second interface use a low data rate from 2 to 4 GBPS (Giga Bit Per Second).

In some embodiments, the first interface and the second interface are two PCI (Peripheral Component Interconnect) interfaces coupled to each other through a wired cable.

In some embodiments, the first interface and the second interface are two wireless interfaces communicating with each other.

In some embodiments, the digital signal is a MIPI (Mobile Industry Processor Interface) signal.

In some embodiments, the data converter performs an uncompressing process on the digital signal, so as to generate the conversion signal.

In some embodiments, the data converter performs a lossless or lossy compressing process on the digital signal, so as to generate the conversion signal.

In some embodiments, the backend module further includes a decompression unit for decompressing the received conversion signal.

In some embodiments, the camera module further includes a microphone element for receiving an audio signal, and the data converter further converts both the digital signal and the audio signal into the conversion signal.

In another exemplary embodiment, the disclosure is directed to a communication method that includes the steps of: generating a digital signal according to an optical signal, converting the digital signal into a conversion signal via a data converter; transmitting the conversion signal via a first interface; receiving the conversion signal via a second interface; and processing the received conversion signal.

In some embodiments, the communication method further includes: performing an uncompressing process on the digital signal via the data converter, so as to generate the conversion signal.

In some embodiments, the communication method further includes: performing a lossless or lossy compressing process on the digital signal via the data converter, so as to generate the conversion signal.

In some embodiments, the communication method further includes: decompressing the received conversion signal.

In some embodiments, the communication method further includes: receiving an audio signal; and converting both the digital signal and the audio signal into the conversion signal via the data converter.

### BRIEF DESCRIPTION OF DRAWINGS

The invention can be more fully understood by reading the subsequent detailed description and examples with references made to the accompanying drawings, wherein:

FIG. 1 is a diagram of a communication system according to an embodiment of the invention:

FIG. 2 is a diagram of a communication system according to an embodiment of the invention;

FIG. 3 is a diagram of a communication system according to an embodiment of the invention;

FIG. 4 is a diagram of a communication system according to an embodiment of the invention:

FIG. 5 is a diagram of a communication system according to an embodiment of the invention;

FIG. 6 is a diagram of a communication system according to an embodiment of the invention; and

FIG. 7 is a flowchart of a communication method according to an embodiment of the invention.

### DETAILED DESCRIPTION OF THE INVENTION

In order to illustrate the purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

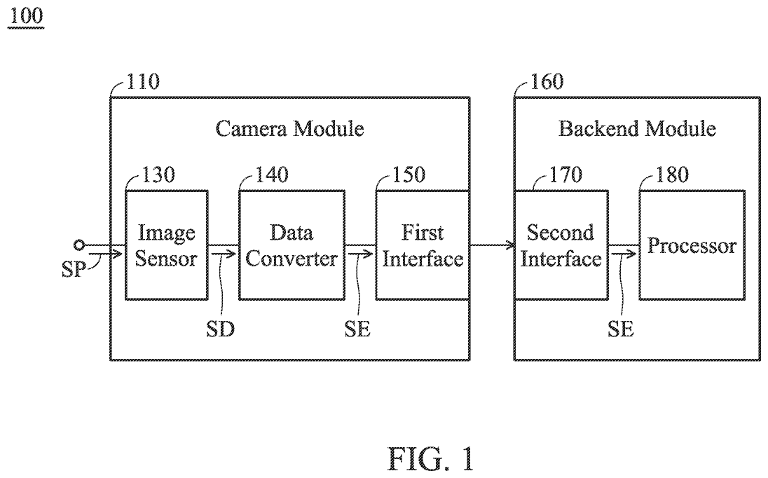

FIG. 1 is a diagram of a communication system 100 according to an embodiment of the invention. The communication system 100 may be applied to a mobile device, such as a smart phone, a tablet computer, or a notebook computer, but it is not limited thereto. As shown in FIG. 1, the communication system 100 includes a camera module 110 and a backend module 160. Specifically, the camera module 110 includes an image sensor 130, a data converter 140, and a first interface 150. The first interface 150 is coupled through the data converter 140 to the image sensor 130. The backend module 160 includes a second interface 170 and a processor 180. The processor 180 is coupled to the second interface 170. The first interface 150 of the camera module 110 and the second interface 170 of the backend module 160 can directly or indirectly communicate with each other.

The image sensor 130 can analyze an optical signal SP, and generate a digital signal SD according to the optical signal SP. For example, the optical signal SP may be received by a lens element (not show), and it may be an image signal or a video signal relative to someone or something. In some embodiments, the digital signal SD is a MIPI (Mobile Industry Processor Interface) signal. The data converter 140 can convert the digital signal SD into a conversion signal SE. For example, the data converter 140 may include a MIPI sensor, a control circuit, and a MCU (Microcontroller Unit) for signal conversion, but it is not limited thereto. Next, the first interface 150 transmits the conversion signal SE. In response, the second interface 170 receives the conversion signal SE. Finally, the processor 180 can process the received conversion signal SE, and perform corresponding operations.

With the proposed design, since the digital signal SD is converted into the conversion signal SE to be transmitted, it involves more data information, and the transmission efficiency of the communication system 100 is significantly improved. In addition, the total manufacturing cost of the communication system 100 is also reduced. The following embodiments will introduce different configurations and detail structural features of the communication system 100. It should be understood that these figures and descriptions are merely exemplary, rather than limitations of the invention.

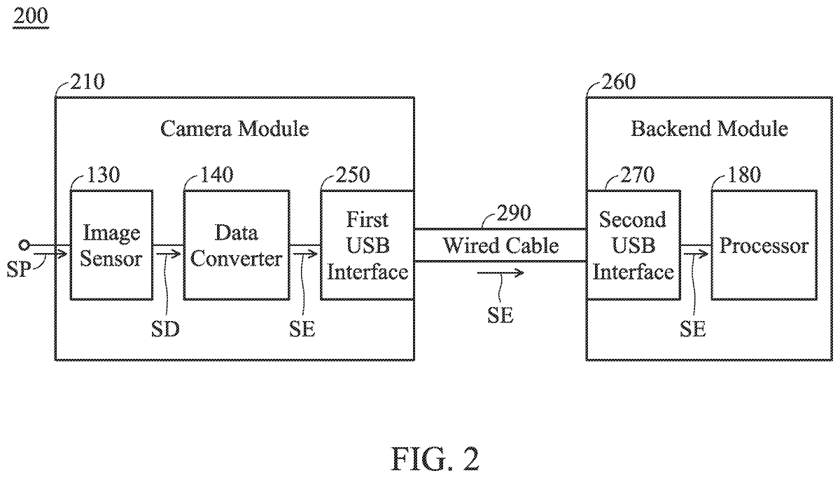

FIG. 2 is a diagram of a communication system 200 according to an embodiment of the invention. FIG. 2 is similar to FIG. 1. In the communication system 200 of the embodiment of FIG. 2, a camera module 210 includes a first USB (Universal Serial Bus) interface 250, and a backend module 260 includes a second USB interface 270. The communication system 200 may further include a wired cable 290, such as a USB cable. The first USB interface 250 and the second USB interface 270 is coupled to each other through the wired cable 290. For example, the digital signal SD is the ISP (Internet Service Provider) unprocessed data. The data converter 140 may pack the digital signal SD into data of the conversion signal SE, which supports the USB transmission protocol. Next, the conversion signal SE can be transmitted and received via the first USB interface 250, the second USB interface 270, and the wired cable 290 therebetween. Because some control signals are integrated with the conversion signal SE, the number of pins of the wired cable 290 can be decreased, and the manufacturing cost of the wired cable 290 can be reduced. Moreover, the communication system 200 can provide more flexible cable routing. The digital signal SD is the ISP unprocessed data, and those are packed and transmitted via the USB protocol directly. Since the ISP unprocessed data can be transmitted to the processor 180 of the backend module 260 for the further processing, the better image quality can be obtained in this embodiment.

In some embodiments, the first USB interface 250 and the second USB interface 270 use a low data rate from 2 to 4 GBPS (Giga Bit Per Second), and it is much lower than 5 GBPS of that of a conventional design. According to practical measurements, such a low data rate can help to suppress the corresponding EMI (Electromagnetic Interference) of the communication system 200, especially for the WLAN (Wireless Local Area Network) 2.4 GHz band. Other features of the communication system 200 of FIG. 2 are similar to those of the communication system 100 of FIG. 1. Therefore, the two embodiments can achieve similar levels of performance.

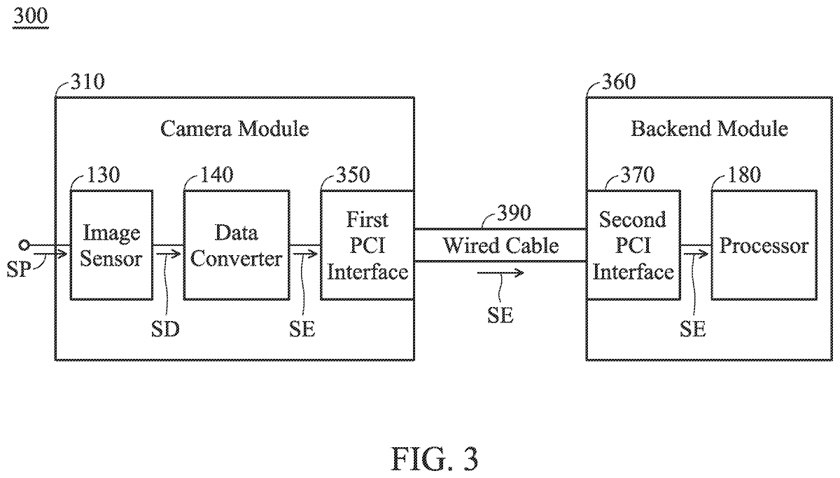

FIG. 3 is a diagram of a communication system 300 according to an embodiment of the invention. FIG. 3 is similar to FIG. 1. In the communication system 300 of the embodiment of FIG. 3, a camera module 310 includes a first PCI (Peripheral Component Interconnect) interface 350, and a backend module 360 includes a second PCI interface 370. The communication system 300 may further include a wired cable 390, such as a PCI cable. The first PCI interface 350 and the second PCI interface 370 is coupled to each other through the wired cable 390. However, the invention is not limited thereto. In alternative embodiments, adjustments are made such that the first PCI interface 350 and the second PCI interface 370 are replaced with other wired connection interfaces. Other features of the communication system 300 of FIG. 3 are similar to those of the communication system 100 of FIG. 1. Therefore, the two embodiments can achieve similar levels of performance.

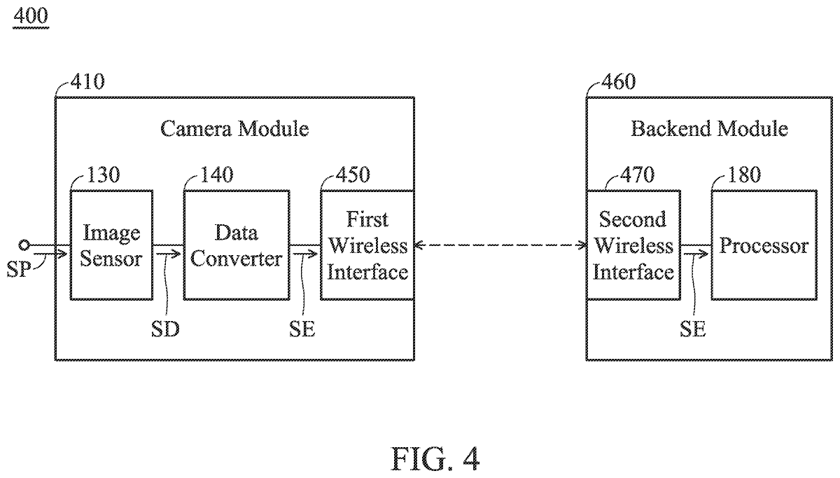

FIG. 4 is a diagram of a communication system 400 according to an embodiment of the invention. FIG. 4 is similar to FIG. 1. In the communication system 400 of the embodiment of FIG. 4, a camera module 410 includes a first wireless interface 450, and a backend module 460 includes a second wireless interface 470. For example, the first wireless interface 450 and the second wireless interface 470 may be two WLAN (Wi-Fi) interfaces or two Bluetooth interfaces, but they are not limited thereto. The first wireless interface 450 and the second wireless interface 470 can communicate with each other in a wireless way. No wired cable is required in the communication system 400. Thus, the cabling cost of the communication system 400 is reduced. Other features of the communication system 400 of FIG. 4 are similar to those of the communication system 100 of FIG. 1. Therefore, the two embodiments can achieve similar levels of performance.

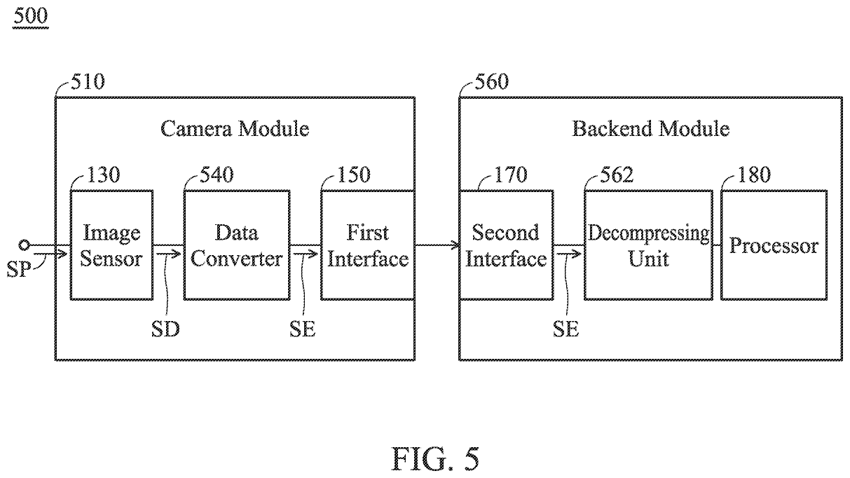

FIG. 5 is a diagram of a communication system 500 according to an embodiment of the invention. FIG. 5 is similar to FIG. 1. In the communication system 500 of the embodiment of FIG. 5, a data converter 540 of a camera module 510 performs a lossless or lossy compressing process on a digital signal SD, so as to generate a conversion signal SE. The data size of the conversion signal SE is relatively because of the aforementioned compression process. Next, the first interface 150 transmits the conversion signal SE in a wired or wireless way, and the second interface 170 receives the conversion signal SE. Furthermore, a backend module 560 further includes a decompression unit 562 for decompressing the received conversion signal SE. The decompression unit 562 is coupled between the second interface 170 and the processor 180. Finally, the processor 180 processes the decompressed conversion signal SE. Other features of the communication system 500 of FIG. 5 are similar to those of the communication system 100 of FIG. 1. Therefore, the two embodiments can achieve similar levels of performance.

It should be understood that the invention is not limited to the above. In alternative embodiments, the data converter 540 perform an uncompressing process on the digital signal SD, so as to generate the conversion signal SE, and the decompression unit 562 is omitted in the backend module 560.

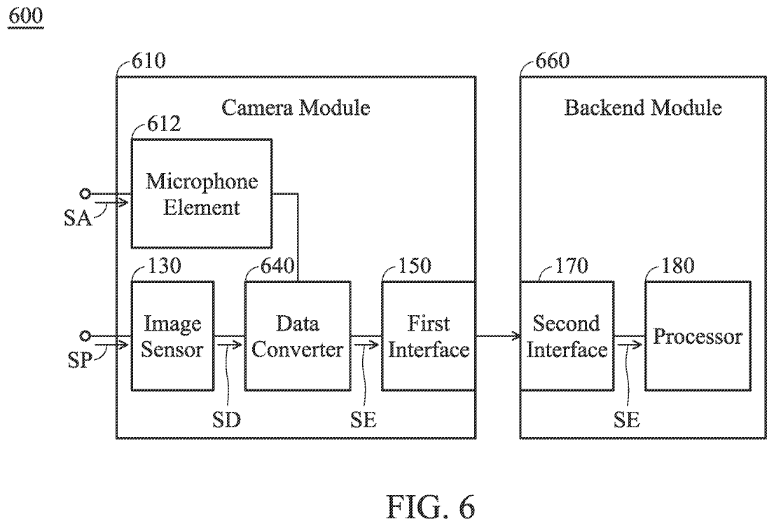

FIG. 6 is a diagram of a communication system 600 according to an embodiment of the invention. FIG. 6 is similar to FIG. 1. In the communication system 600 of the embodiment of FIG. 6, a camera module 610 further includes a microphone element 612 for receiving an audio signal SA from someone or something, and a data converter 640 of the camera module 610 converts both the digital signal SD and the audio signal SA into a conversion signal SE. That is, the conversion signal SE integrates information of the optical signal SP with that of the audio signal SA. With such a design, the communication system 600 does not need an additional cable for transmitting the audio signal SA, so that the manufacturing cost of the communication system 600 can be reduced. Other features of the communication system 600 of FIG. 6 are similar to those of the communication system 100 of FIG. 1. Therefore, the two embodiments can achieve similar levels of performance.

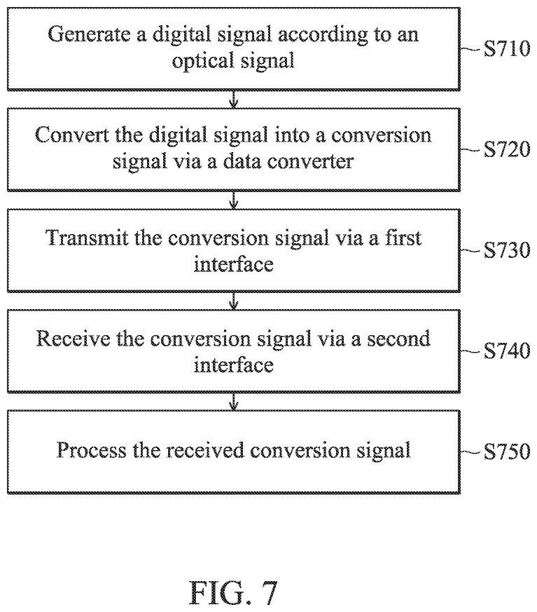

FIG. 7 is a flowchart of a communication method according to an embodiment of the invention. The aforementioned communication method includes the following steps. In the step S710, a digital signal is generated according to an optical signal. In the step S720, the digital signal is converted into a conversion signal via a data converter. In the step S730, the conversion signal is transmitted via a first interface. In the step S740, the conversion signal is received via a second interface. In the step S750, the received conversion signal is processed. It should be noted that the above steps are not required to be performed in order, and all of the features of the embodiments of FIGS. 1 to 6 may be applied to the communication method of FIG. 7.

The invention proposes a novel communication system and a novel communication method thereof. Compared to the conventional design, the invention has at least the advantages of high transmission efficiency and low manufacturing cost, and therefore it is suitable for application in a variety of mobile communication devices.

Note that the above element parameters are not limitations of the invention. An designer can fine-tune these settings or values according to different requirements. It should be understood that the communication system and the communication method of the invention are not limited to the configurations of FIGS. 1-7. The invention may merely include any one or more features of any one or more embodiments of FIGS. 1-7. In other words, not all of the features displayed in the figures should be implemented in the communication system and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication system, comprising:
a camera module, comprising:
an image sensor, generating a digital signal according to an optical signal;
a data converter, converting the digital signal into a conversion signal; and
a first interface, transmitting the conversion signal; and
a backend module, comprising:
a second interface, receiving the conversion signal; and
a processor, processing the received conversion signal.

2. The communication system as claimed in claim 1, wherein the first interface and the second interface are two USB (Universal Serial Bus) interfaces coupled to each other through a wired cable.

3. The communication system as claimed in claim 2, wherein the first interface and the second interface use a low data rate from 2 to 4 GBPS (Giga Bit Per Second).

4. The communication system as claimed in claim 1, wherein the first interface and the second interface are two PCI (Peripheral Component Interconnect) interfaces coupled to each other through a wired cable.

5. The communication system as claimed in claim 1, wherein the first interface and the second interface are two wireless interfaces communicating with each other.

6. The communication system as claimed in claim 1, wherein the digital signal is a MIPI (Mobile Industry Processor Interface) signal.

7. The communication system as claimed in claim 1, wherein the data converter performs an uncompressing process on the digital signal, so as to generate the conversion signal.

8. The communication system as claimed in claim 1, wherein the data converter performs a lossless or lossy compressing process on the digital signal, so as to generate the conversion signal.

9. The communication system as claimed in claim 8, wherein the backend module further comprises a decompression unit for decompressing the received conversion signal.

10. The communication system as claimed in claim 1, wherein the camera module further comprises a microphone element for receiving an audio signal, and the data converter further converts both the digital signal and the audio signal into the conversion signal.

11. A communication method, comprising the steps of:
generating a digital signal according to an optical signal;
converting the digital signal into a conversion signal via a data converter;
transmitting the conversion signal via a first interface;
receiving the conversion signal via a second interface; and
processing the received conversion signal.

12. The communication method as claimed in claim 11, wherein the first interface and the second interface are two USB (Universal Serial Bus) interfaces coupled to each other through a wired cable.

13. The communication method as claimed in claim 12, wherein the first interface and the second interface use a low data rate from 2 to 4 GBPS (Giga Bit Per Second).

14. The communication method as claimed in claim 11, wherein the first interface and the second interface are two PCI (Peripheral Component Interconnect) interfaces coupled to each other through a wired cable.

15. The communication method as claimed in claim 11, wherein the first interface and the second interface are two wireless interfaces communicating with each other.

16. The communication method as claimed in claim 11, wherein the digital signal is a MIPI (Mobile Industry Processor Interface) signal.

17. The communication method as claimed in claim 11, further comprising:
performing an uncompressing process on the digital signal via the data converter, so as to generate the conversion signal.

18. The communication method as claimed in claim 11, further comprising:
performing a lossless or lossy compressing process on the digital signal via the data converter, so as to generate the conversion signal.

19. The communication method as claimed in claim 18, further comprising:
decompressing the received conversion signal.

20. The communication method as claimed in claim 11, further comprising:
receiving an audio signal; and
converting both the digital signal and the audio signal into the conversion signal via the data converter.
